(19) United States
(12) Patent Application Publication
(10) Pub. No.: US 2026/0195562 A1
(43) Pub. Date: Jul. 9, 2026

(54) SKIPPING LAYERS IN LARGE LANGUAGE MODELS UTILIZING LAYER-SPECIFIC ROUTERS WITH LOW RANK ADAPTERS

(71) Applicant: Adobe Inc., San Jose, CA (US)

(72) Inventors: Akriti Jain, Ghaziabad (IN); Saransh Sharma, Mundra (IN); Koyel Mukherjee, Bangalore (IN); Soumyabrata Pal, Bengaluru (IN); Aayush M Acharya, Bangalore (IN); Saud Iqbal, Delhi (IN)

(21) Appl. No.: 19/009,212

(22) Filed: Jan. 3, 2025

(51) Int. Cl. G06N 3/04

(52) U.S. Cl. CPC G06N 3/04

(57) ABSTRACT

The present disclosure relates to systems, non-transitory computer-readable media, and methods for generating a response to a query using a large language model by skipping a query-specific set of layers of the large language model. In particular, the disclosed systems generate, using a large language model and in response to a query to the large language model, a first token in a prefill phase for an input sequence from the query. Additionally, the disclosed systems determine, during the prefill phase and utilizing a layer-specific router corresponding to a layer of the large language model, a probability value indicating to skip the layer of the large language model. Further, the disclosed systems generate, using the large language model, a second token in a subsequent phase by skipping the layer of the large language model based on the probability value.

### BACKGROUND

Recent years have seen significant improvements in the role of large language models in performing artificial intelligence and machine learning tasks. For example, large language models are powerful tools for understanding, generating, and transforming natural language, serving as foundational components for applications like chatbots, summarization, code generation, and decision-making systems. A major challenge of large language models is their high computational expense, requiring significant computing resources for implementation into artificial intelligence and machine-learning applications. Specifically, due to the large number of parameters that many large language models include, maintaining low latency when deploying large language models on resource-constrained edge devices like laptops and mobile phones is often challenging. Indeed, conventional systems have a number of drawbacks that negatively impact the flexibility and accuracy of large language models on edge devices.

### SUMMARY

Embodiments of the present disclosure provide benefits and/or solve one or more of the foregoing or other problems in the art with systems, non-transitory computer-readable media, and methods for generating an artificial intelligence (AI) response to a query using a large language model by skipping a query-specific set of layers of the large language model. In particular, in a prefill phase, the disclosed systems utilize layer-specific routers to generate a probability value for each layer of the large language model indicating whether or not the layer should be skipped in subsequent phases. Further, the disclosed systems use the large language model to generate tokens of the response to the query by skipping a set of one or more layers of the large language model based on the probability values of the layers. Moreover, in some embodiments, the disclosed systems finetune the parameters of the layers of the large language model using low rank adapters.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a layer modulation system operates in accordance with one or more embodiments.

FIG. 2 illustrates an overview diagram of the layer modulation system generating a response to a query using a large language model and query-specific layer skipping in accordance with one or more embodiments.

FIG. 3 illustrates a diagram of the layer modulation system using inference phases of a large language model in accordance with one or more embodiments.

FIG. 4 illustrates a diagram of the layer modulation system determining a probability value for determining whether to skip a layer of the large language model in a prefill phase in accordance with one or more embodiments.

FIG. 5 illustrates a diagram of the layer modulation system generating tokens of a response to a query by skipping a set of one or more layers of a large language model in subsequent inference phases in accordance with one or more embodiments.

FIG. 6 illustrates a diagram of the layer modulation system finetuning the parameters of the large language model using low rank adapters in accordance with one or more embodiments.

FIG. 7 illustrates a diagram of the layer modulation system skipping a query-specific set of layers of a large language model to generate response tokens in accordance with one or more embodiments.

FIGS. 8A and 8B illustrate layer skipping statistics of the layer modulation system across different datasets for different tasks in accordance with one or more embodiments.

FIG. 9 illustrates large language model response metrics achieved by the layer modulation system compared with example prior art large language model response metrics in accordance with one or more embodiments.

FIG. 10 illustrates an example schematic diagram of the layer modulation system in accordance with one or more embodiments.

FIG. 11 illustrates a flowchart of an example series of acts for generating an artificial intelligence response to a query using a large language model by skipping a query-specific set of layers of the large language model in accordance with one or more embodiments.

FIG. 12 illustrates a block diagram of an example computing device for implementing one or more embodiments of the present disclosure.

### DETAILED DESCRIPTION

This disclosure describes one or more embodiments of a layer modulation system that generates an AI response to a query using a large language model by skipping a query-specific set of layers of the large language model. Specifically, in a prefill phase, the layer modulation system uses layer-specific routers to generate a probability value for each layer of the large language model indicating whether or not the layer should be skipped. Furthermore, the layer modulation system uses the large language model to generate tokens of the response by skipping a set of one or more layers of the large language model based on the probability values of the layers. Additionally, in some implementations, the layer modulation system finetunes the parameters of the layers of the large language model using low rank adapters.

As mentioned above, in one or more embodiments, the layer modulation system determines a probability value for each layer of the large language model in a prefill phase for a query. In particular, the probability values indicate whether or not the layer should be skipped for the query. For instance, in one or more implementations, the layer modulation system utilizes a layer-specific router corresponding to each layer of the large language model to determine the probability values. Further, in some embodiments, the layer modulation system caches the probability value for each layer as an attribute of the layer-specific router for access during later inference phases.

As noted above, in some implementations, the layer modulation system uses the large language model to generate tokens of the response by skipping a set of one or more layers of the large language model based on the probability values of the layers. Specifically, the layer modulation system determines the set of layers to skip in inference phases subsequent to the prefill phase based on the cached probability values. For example, the layer modulation system accesses the cached probability values for each layer in the corresponding layer-specific routers to determine whether each layer should be skipped or not. In these or other embodiments, the layer modulation system skips the same layers (i.e., a query-specific set of layers) in each subsequent inference phase when generating the tokens of a response.

As mentioned previously, in one or more embodiments, the layer modulation system finetunes the parameters of the layers of the large language model using low rank adapters. In particular, the layer modulation system uses low rank adapters associated with each layer of the large language model to finetune the parameters of the layers. For instance, in one or more implementations, the layer modulation system uses a low rank adapter for each of an attention head and a feedforward network associated with each layer to finetune the layer parameters.

Although conventional systems implement large language models for various natural language query tasks, such systems have a number of problems in relation to efficiency, flexibility of operation, and accuracy. For instance, conventional systems inefficiently and inflexibly deploy large language models, particularly on devices with limited computing resources (e.g., limited processing and memory resources) such as edge devices. Specifically, conventional systems implementing large language models on devices with limited computing resources have high-latency because they lack adequate implementation methods to reduce the latency. Further, this high latency is exacerbated due to the sequential nature of decoding tokens during response generation in auto-regressive models, indicating that the latency is directly related to the size or number of layers in the large language model architecture. Additionally, while some conventional systems are capable of layer skipping for reduced latency, these conventional systems are not capable of utilizing key-value caching with layer skipping. For such systems any efficiency gains resulting from the layer skipping are outweighed by the latency resulting from the inability to incorporate key-value caching. Furthermore, conventional systems demonstrate operational inflexibility as a result of the high latency, making deployment of large language models on edge devices impractical due to the high latency, limiting their usefulness to server devices with high resource availability.

In addition to their inefficiencies and rigidity, conventional systems inaccurately implement large language models on devices with limited computing resources. More specifically, some conventional systems employ implementation strategies to attempt to minimize latency on devices with limited computing resources resulting in high performance degradation. For instance, some conventional systems attempt to minimize the required resources for response generation by (i) pre-training the model to skip certain layers, (ii) compressing the model parameters, (iii) pruning the network to construct smaller sub-networks, or (iv) distilling the large model into a smaller model. As mentioned, each of these approaches results in high performance degradation due to a variety of causes such as failing to train the model for a specific input (e.g., the models are trained to use the same set of layers for every query), or because the heuristic rules are not appropriate to model the input or depend on sequence length of the query, which is often highly variable.

As suggested by the foregoing, embodiments of the layer modulation system provides a variety of improvements relative to conventional systems. For example, by predicting and skipping specific layers of a large language model for a given query, the layer modulation system improves efficiency and flexibility of operation relative to conventional systems. Specifically, the layer modulation system improves efficiency by determining a set of layers of the large language model to skip via layer-specific routers in a prefill phase (or first inference phase). By skipping layers during inference, in some implementations, the layer modulation system reduces the compute resources required for response generation, thereby reducing the latency due to the time and resources often involved in generating tokens in auto-regressive decoding operations via a large language model.

In addition, by ensuring that the key-value cache for previous tokens is available for a given layer, the layer modulation system also improves efficiency relative to conventional systems. Specifically, the layer modulation system ensures that the key-value cache for previous tokens is available for a given layer by skipping the same set of layers for a given input in each subsequent inference phase. For example, in some embodiments, the layer modulation system caches the probability values for the layers of the large language model in the prefill phase and uses these cached probability values to skip the same set of layers of the large language model in each of the subsequent phases of inference. Accordingly, the layer modulation system is compatible with existing fast inference techniques such as existing key-value caching mechanisms. Indeed, the layer modulation system is capable of integration into any open-source large language model with minimal modifications.

Moreover, in one or more embodiments, the layer modulation system improves flexibility of operation by utilizing a customizable hyperparameter to modify the extent of layer skipping specific to the query based on available computing resources. In these or other embodiments, the layer modulation system utilizes the large language model to generate responses with low latency on a wide variety of devices regardless of the computing resources available.

Furthermore, in one or more implementations, by predicting and skipping redundant layers of the large language model and finetuning the parameters of the large language model, the layer modulation system improves accuracy relative to conventional systems. In particular, the layer modulation system skips layers during inference based on the specific input sequence of the query as described above. By customizing the layers to skip for each separate input, the layer modulation system generates more accurate responses using the large language model while maintaining low latency as described.

Additionally, in some embodiments, the layer modulation system finetunes the parameters of the large language model layers using low rank adapters to improve performance while retaining a similar amount of layer skipping through the inference phases for a given query. In these or other embodiments, the layer modulation system not only improves the accuracy of the response generation but does so in a manner that maintains low latency. For instance, the layer modulation system finetunes the parameters of the large language model layers to more accurately generate learned hidden states while avoiding degradation common in conventional systems, resulting in more accurate response generation. Indeed, in these or other embodiments, the use of the low rank adapters allows the layer modulation system to perform the finetuning with relatively few computing resources.

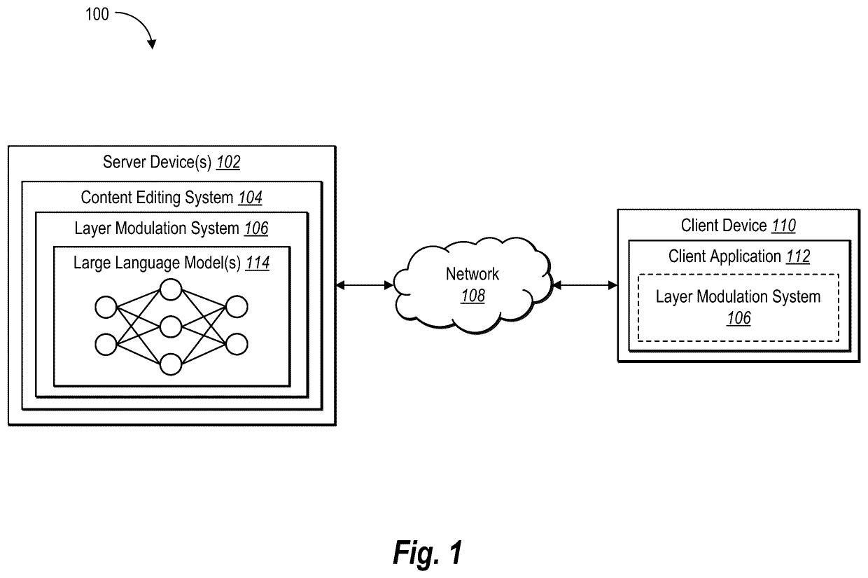

Additional detail regarding the layer modulation system 106 will now be provided with reference to the figures. For example, FIG. 1 illustrates a schematic diagram of a system environment 100 in which a layer modulation system 106 operates. As illustrated in FIG. 1, the system environment 100 includes server device(s) 102, a network 108, and a client device 110. Although the system environment 100 of FIG. 1 is depicted as having a particular number of components, the system environment 100 is capable of having any number of additional or alternative components (e.g., any number of server devices, client devices, or other components in communication with the layer modulation system 106 via the network 108). Similarly, although FIG. 1 illustrates a particular arrangement of the server device(s) 102, the network 108, and the client device 110, various additional arrangements are possible.

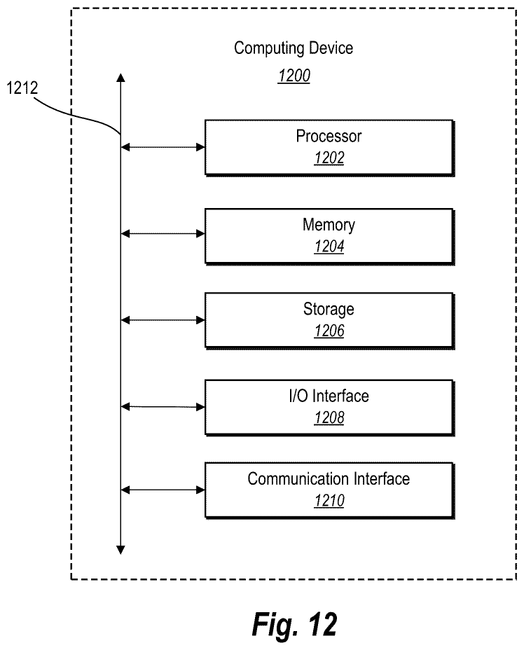

The server device(s) 102, the network 108, and the client device 110 are communicatively coupled with each other either directly or indirectly (e.g., through the network 108 discussed in greater detail below in relation to FIG. 12). Moreover, the server device(s) 102 and the client device 110 include one or more of a variety of computing devices (including one or more computing devices as discussed in greater detail with relation to FIG. 12).

As mentioned above, the system environment 100 includes the server device(s) 102. In one or more embodiments, the server device(s) 102 generates, stores, receives, and/or transmits data including notifications, models, and queries. In one or more embodiments, the server device(s) 102 comprises a data server. In some implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device 110) views, generates, stores, and/or edits digital content including artificial intelligence content (e.g., in connection with performing question-answering tasks). For example, in some instances, a client device sends a query to the content editing system 104 hosted on the server device(s) 102 via the network 108. The content editing system 104 then provides options usable by the client device to generate and/or edit the digital content (such as responses to queries), store the digital content, and subsequently search for, access, and view the digital content. To illustrate, the content editing system 104 provides one or more options that are usable by the client device to train one or more large language models and/or generate content therefrom.

As further shown, the server device(s) 102 also include the layer modulation system 106 to train large language models (e.g., the large language model(s) 114) to generate content such as text therefrom in the content editing system 104. In one or more embodiments, the layer modulation system 106 uses (e.g., during a prefill phase of the large language model(s) 114 for a query) layer-specific routers of the layers of the large language model to generate a probability value for each layer of the large language model indicating whether to skip the layer. In particular, as will be explained below, the layer modulation system 106 uses the probability values for the layers of the large language model to determine which layers to skip while generating tokens of the response using the large language model. Additionally, the layer modulation system 106 trains the layers of the large language model using low rank adapters while freezing the parameters of the layer-specific routers. Further, the layer modulation system 106 accesses the large language model with parameters of the layer-specific routers and layers of the model modified as just described to generate a response to a query while skipping layers based on the probability values.

As illustrated in FIG. 1, the layer modulation system 106 includes a large language model(s) 114. Indeed, in these or other embodiments, the layer modulation system 106 accesses the large language model(s) 114 to modify parameters thereof or implements the large language model(s) 114 to generate and/or implement responses to queries such as summaries, answers to questions, machine translations, etc. In some cases, the large language model(s) 114 are external to the layer modulation system 106, but the layer modulation system 106 nevertheless accesses and utilizes the large language model(s) 114 via one or more plugins, APIs, or other network-based access protocols.

In one or more embodiments, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model. In one or more embodiments, a neural network includes a single layer, such as a multilayer perceptron.

In one or more implementations, the large language model(s) 114 includes an artificial intelligence model capable of processing and generating natural language text or other language-based prompts using language understanding. In particular, large language models are trained on large amounts of data to learn patterns and rules of language, such as for summarizing and/or generating text. As such, a large language model is capable of generating output predictions such as predicted text (e.g., left-to-right predicted text). Further, in some embodiments, a large language model includes or refers to one or more decoder-only large language models capable of processing language-based prompts (e.g., natural language text) to generate outputs such as responses to queries.

In one or more embodiments, the client device 110 includes a computing device that accesses, edits, segments, modifies, stores, and/or provides, for display, digital content such as digital documents with artificial intelligence generated content. For example, in some embodiments, the client device 110 includes a smartphone, a tablet, a desktop computer, a laptop computer, a head-mounted-display device, or another electronic device, including those explained below with reference to FIG. 12. In some instances, the client device 110 includes one or more applications (e.g., a client application 112) that access, edit, segment, modify, store, and/or provide, for display, digital content such as digital documents with artificial intelligence generated content. For example, in one or more embodiments, the client application 112 includes a software application installed on the client device 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device 110 communicates via the network using one or more communication platforms and technologies suitable for transporting data and/or communication signals, including any known communication technologies, devices, media, and protocols supportive of data communications, examples of which are described with reference to FIG. 12.

To provide an example implementation, in some embodiments, the layer modulation system 106 on the server device(s) 102 supports the layer modulation system 106 on the client device 110. For instance, in some cases, the layer modulation system 106 generates or trains the large language model(s) 114 on the server device(s) 102. The layer modulation system 106 then, via the server device(s) 102, provides the large language model(s) 114 to the client device 110. In other words, the client device 110 obtains (e.g., downloads) the large language model(s) 114 from the server device(s) 102. Once downloaded, the layer modulation system 106 on the client device 110 uses the large language model(s) 114 to train and or implement the large language models to generate outputs such as responses to queries independent of the server device(s) 102. In some implementations, the layer modulation system 106 generates or trains the large language model(s) 114 on the client device 110.

In alternative implementations, the layer modulation system 106 includes a web hosting application that allows the client device 110 to interact with content and services hosted on the server device(s) 102. To illustrate, in one or more implementations, the client device 110 accesses a software application supported by the server device(s) 102. The client device 110 provides input to the server device(s) 102, such as a training data and/or queries for use as input and/or for incorporation with the output of large language model. In response, the layer modulation system 106 on the server device(s) 102 generates modified parameters of a large language model or generated responses using the large language model with the modified parameters. The server device(s) 102 then provides the generated responses to the client device 110 for display and/or further processing.

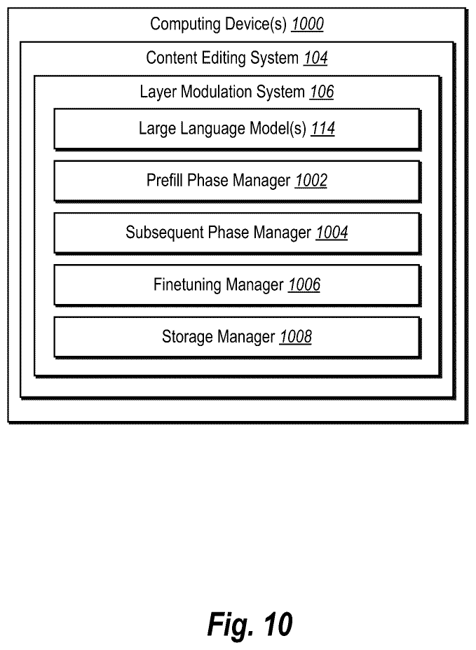

Although FIG. 1 illustrates the layer modulation system 106 implemented with regard to the server device(s) 102, different components of the layer modulation system 106 are able to be implemented by a variety of devices within the system environment 100. For example, in some instances, a different computing device (e.g., the client device 110) or a separate server from the server device(s) 102 implements one or more (or all) components of the layer modulation system 106. Indeed, as shown in FIG. 1, the client device 110 includes the layer modulation system 106. Example components of the layer modulation system 106 will be described below with regard to FIG. 10.

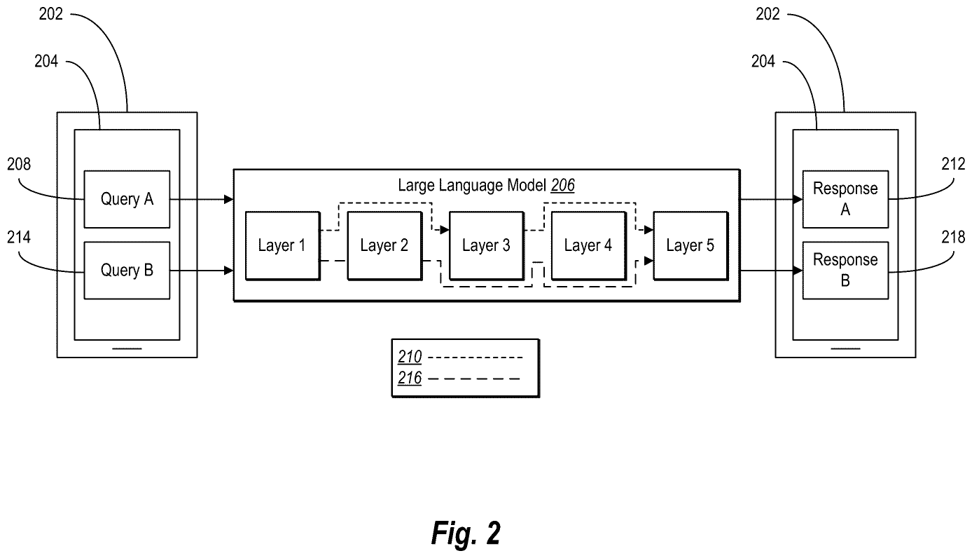

As noted previously, in some implementations, the layer modulation system 106 generates an AI response (also referred to simply as a “response”) to a query using a large language model by skipping a query-specific set of layers of the large language model. Specifically, in one or more embodiments, the layer modulation system uses this query-specific approach for client devices with low computing resource availability. FIG. 2 illustrates an overview diagram of the layer modulation system generating a response to a query using a large language model and query-specific layer skipping in accordance with one or more embodiments.

As illustrated in FIG. 2, in one or more implementations, the layer modulation system 106 receives queries (e.g., query A 208 and query B 214) to a large language model 206 from an AI interface 204 of a client device 202. In particular, in some embodiments, the layer modulation system 106 determines that the client device 202 is computing resource constrained. For example, in some implementations, the layer modulation system 106 determines that the client device 202 includes hardware or software capabilities insufficient to perform certain computational tasks efficiently or effectively. Specifically, in one or more embodiments, such a computing resource constrained client device include constraints in processing power, memory capacity, storage availability, network bandwidth, or energy efficiency. For example, a computing resource constrained computing device includes a client device with low-performance processors, minimal RAM, small storage drives, slow network connections, or restricted battery life, such as smartphones, laptops, etc.

In one or more implementations, the layer modulation system 106 determines a query-specific set of layers to skip to generate the responses (e.g., response A and response B) with the large language model 206. Specifically, based on determining that the client device 202 is resource constrained, the layer modulation system 106 determines the query-specific set of layers. Additionally, or alternatively, in some embodiments, the layer modulation system 106 determines that faster inference is required such as through user interaction with the client device. In these or other embodiments, the layer modulation system 106 determines the query-specific set of layers based on the faster inference requirement.

As further illustrated in FIG. 2, in some implementations, the layer modulation system 106 receives query A 208 and generates response A 212 using the large language model 206. In particular, the layer modulation system 106 determines a set of layers of the large language model 206 specific to query A 208 to skip as illustrated by pathway 210. In this example, the layer modulation system 106 uses layers 1, 3, and 5 of the large language model 206 but skips layers 2 and 4 to generate response A 212, where the large language model 206 is simplified for illustrative purposes.

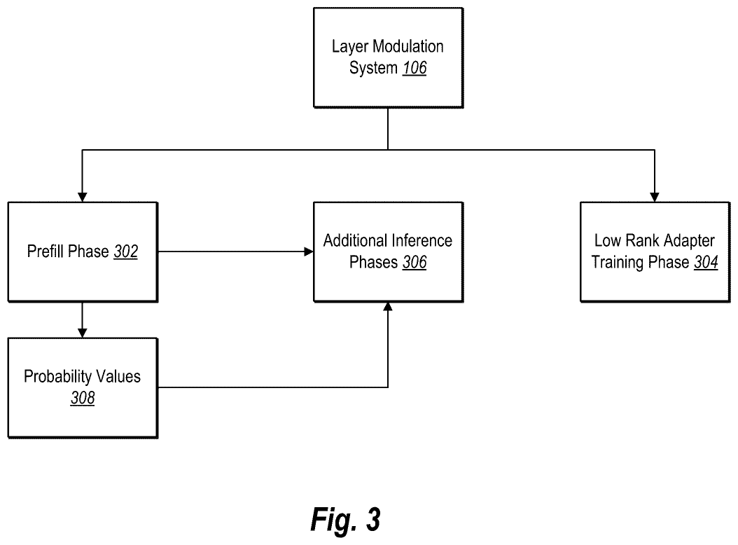

As additionally shown in FIG. 2, in one or more embodiments, the layer modulation system 106 receives query B 214 and generates response B 218. Specifically, the layer modulation system 106 determines an additional set of layers of the large language model 206 specific to query B 214 to skip as illustrated by pathway 216. In this example, the layer modulation system 106 uses layers 1, 2, and 5 of the large language model 206 but skips layers 3 and 4 to generate response B 218. Additional detail regarding generating responses using layer skipping with a large language model as just described is provided with respect to FIGS. 3-10.

As previously mentioned, in one or more implementations, the layer modulation system 106 generates responses using layer skipping with a large language model. Indeed, in some embodiments, the layer modulation system 106 utilizes one or more phases of inference of the large language model to generate tokens by skipping query-specific sets of layers when generating responses. FIG. 3 illustrates a diagram of the layer modulation system 106 using inference phases of a large language model in accordance with one or more embodiments.

As shown in FIG. 3, in some implementations, the layer modulation system 106 trains layer-specific routers to generate probability values 308 in a prefill phase 302 for a query. In particular, the layer modulation system 106 utilizes layer-specific routers to determine a probability value for each layer of the large language model in the prefill phase 302. In one or more embodiments, the probability value for a layer indicates whether to skip the layer or not in subsequent phases of inference. Specifically, the probability value indicates whether to use an input to the layer and the layer of the large language model to generate an output from that layer as discussed in further detail below. For instance, in one or more implementations, the probability value of a layer includes a probability value in the interval [0, 1].

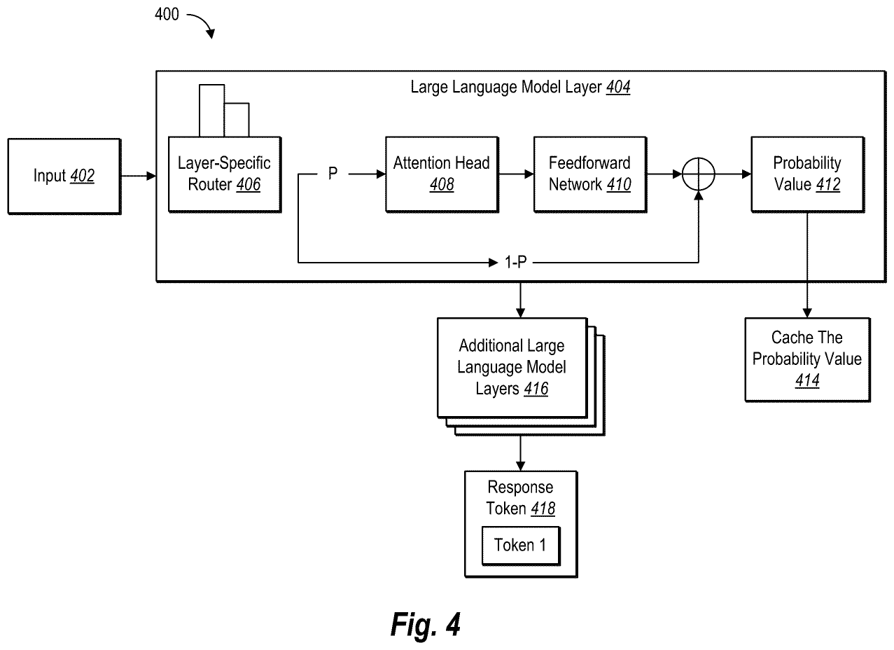

Additionally and as mentioned above, in some embodiments, the layer modulation system 106 trains the layer-specific routers corresponding to the layers of the large language model in the prefill phase 302. Further, in some implementations, the layer modulation system 106 generates a token (e.g., the first token) of a response to a query (e.g., query A 208 or query B 214) in the prefill phase utilizing all layers of the large language model. Additional detail regarding the generating the probability values 308 and training the layer-specific routers in the prefill phase 302 is provided with respect to FIG. 4.

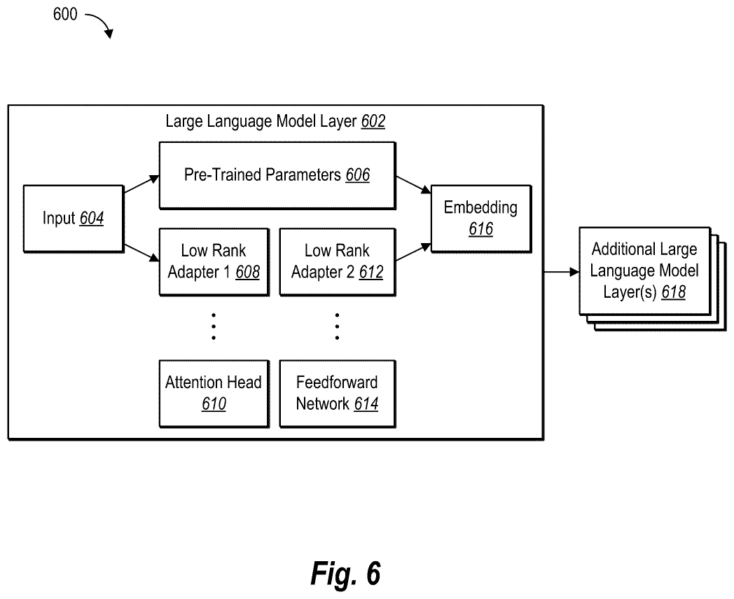

As further illustrated in FIG. 3, in one or more embodiments, the layer modulation system 106 trains the layers of a large language model in a low rank adapter training phase 304 separate from training the layer-specific routers. In particular, the layer modulation system 106 modifies the parameters of the layers of the large language model using the low rank adapters. For example, the layer modulation system 106 modifies the parameters of the layers of the large language model while freezing the parameters of the layer-specific routers. Additional detail regarding training the layers of the large language model in the low rank adapter training phase 304 is provided with respect to FIG. 6.

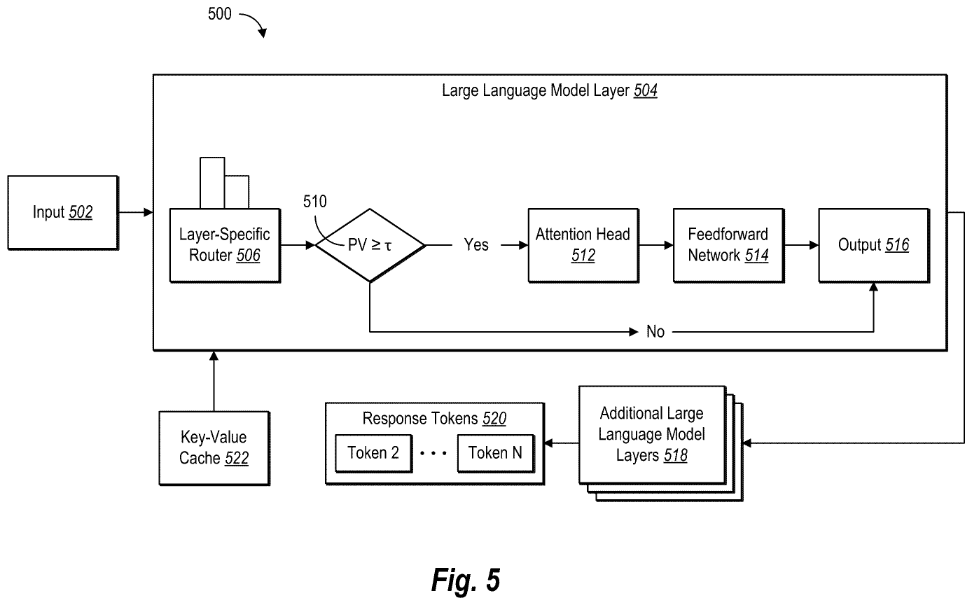

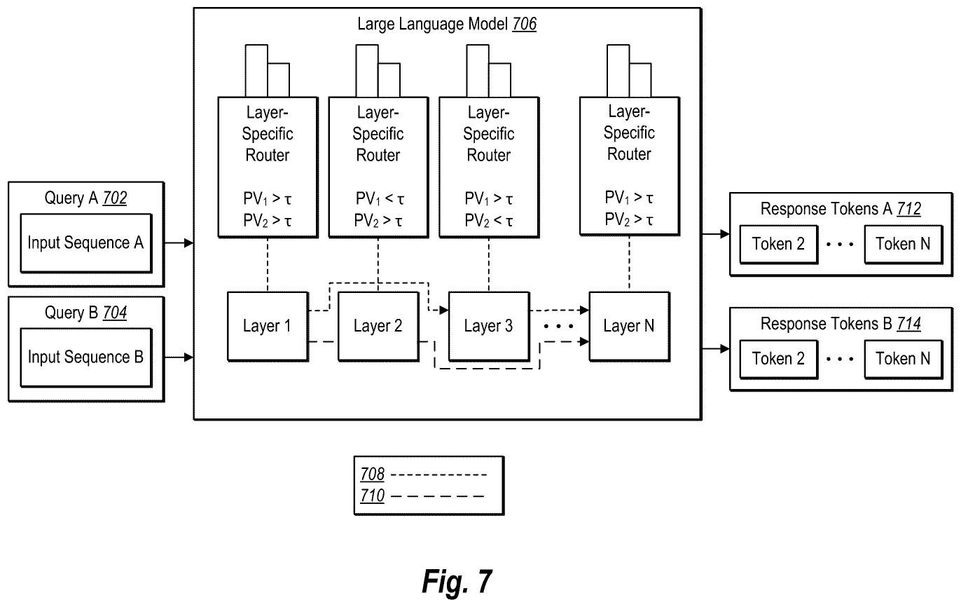

As also depicted in FIG. 3, in one or more implementations, the layer modulation system 106 performs additional inference phases 306 of the large language model. Specifically, the layer modulation system 106 generates additional tokens of the response to the query by skipping a query-specific set of layers of the large language model in the additional inference phases 306. For instance, the layer modulation system 106 uses the probability values 308 to determine the query-specific set of layers to skip when generating the additional tokens of the response in the additional inference phases 306. Additional detail regarding the additional inference phases 306 is provided with respect to FIGS. 5 and 7.

As previously noted, in some embodiments, the layer modulation system 106 determines a probability value for each layer of the large language model in a prefill phase. Indeed, in some implementations, the layer modulation system 106 utilizes a layer-specific router to determine the probability value for each layer. FIG. 4 illustrates a diagram of the layer modulation system 106 determining the probability value for a layer of the large language model in a prefill phase in accordance with one or more embodiments.

As portrayed in FIG. 4, in one or more embodiments, the layer modulation system 106 trains layer-specific routers (e.g., layer-specific router 406) corresponding to layers of a large language model layer (e.g., of the large language model 206) in a prefill phase 400. Specifically, the prefill phase 400 includes an inference phase of the large language model. For example, in one or more implementations, the prefill phase 400 includes a first phase of inference of the large language model by which the layer modulation system 106 generates a response token 418 (e.g., token 1) of the response to a query to the large language model.

As further illustrated in FIG. 4, in some embodiments, the layer modulation system 106 uses an input 402 to train the layer-specific router 406 corresponding to the large language model layer 404. In particular, the layer modulation system 106 uses a tokenized input sequence of a query to the large language model as the input 402 for the first layer of the large language model. In some implementations, the input sequence includes alpha numeric characters of the query. For layers of the large language model subsequent to the first layer, in one or more embodiments, the layer modulation system 106 uses the output (e.g., hidden state) of a preceding layer as the input 402.

As mentioned above, in one or more implementations, the layer modulation system 106 trains the layer-specific router 406 corresponding to the large language model layer 404. In particular, in some embodiments, the layer-specific router 406 includes a layer of a neural network. For instance, in some implementations, the layer-specific router 406 includes a single-layer neural network (without bias), such as a single multilayer perceptron, positioned before the large language model layer 404. In these or other embodiments, the layer modulation system 106 modifies the parameters of the layer-specific router 406 in a layer-specific router training phase. In one or more embodiments, the layer-specific router training phase includes a first training phase of a series of training phases.

As additionally shown in FIG. 4, in one or more implementations, the layer modulation system 106 determines a probability value 412 indicating a probability of not skipping the large language model layer 404 for the query based on the input 402. Specifically, the layer modulation system 106 uses the layer-specific router 406 to determine the probability value 412. For example, in some embodiments, by training (e.g., modifying the parameters of) the layer-specific router 406, the layer modulation system 106 determines the probability value 412.

To illustrate mathematically, for any large language model layer l, the layer-specific router receives as input a B×T×C tensor (e.g., output of layer l−1) and outputs a B×T×1 tensor. Moreover, in some implementations, corresponding to each token in the B×T×1 tensor, the layer modulation system 106 applies a sigmoid function to ensure all entries in the tensor are in the interval [0, 1]. Furthermore, in one or more embodiments, the layer modulation system 106 performs a mean operation at the sequence level (e.g., generating a mean from all the weights in a sequence to output a B×1×1 tensor) for each sequence in a batch during batch decoding operations. In these or other embodiments, the corresponding entry is the probability with which the sequence skips the layer/(i.e., the probability value 412).

Additionally, in one or more implementations, to modify the parameters of the layer-specific router 406, the layer modulation system 106 modifies the output of a previous layer of the large language model using a skip connection. Specifically, in some embodiments, the layer modulation system 106 trains the layer-specific router 406 to encourage layer skipping by reducing the probability of not skipping (i.e., prob) the large language model layer 404. For example, in the output tensor of the previous layer y=prob*layer(x)+(1−prob)*x, the layer modulation system 106 reduces prob using a regularizer. Further, in some implementations, the layer modulation system 106 freezes the entire model except for the layer-specific routers corresponding to each layer of the large language model while training the layer-specific routers. Moreover, in one or more embodiments, the layer modulation system 106 models the layer-specific router training task as a language modeling task (e.g., next token prediction).

To illustrate, the layer modulation system 106 uses the skip connection as shown in FIG. 4. In particular, with probability p, the layer modulation system 106 uses the large language model layer 404 to process the input 402 through an attention head 408 and feedforward network 410. To further illustrate, with probability 1−p, the layer modulation system 106 skips the large language model layer 404.

Furthermore, in one or more implementations, the layer modulation system 106 modifies the parameters of the layer-specific router 406 using a cross-entropy loss, a regularization loss, and/or a probability penalization loss. For instance, in some embodiments, the layer modulation system 106 modifies the parameters of the layer-specific router 406 based on a total loss including each of the cross-entropy loss, the regularization loss, and the probability penalization loss. Indeed, in these or other embodiments, the layer modulation system 106 determines the total loss as follows:

$$Cross - Entropy Loss + λ Regularization Loss on Router Parameters + α {\sum }_{layers} prob$$

In the total loss, prob refers to the probability of not skipping a given layer, as described above.

In some implementations, the cross-entropy loss is based on predicted probability distributions of the large language model. For example, in one or more embodiments, the layer modulation system 106 uses the cross-entropy loss to measure the difference between the actual and predicted probability distributions. Additionally, in one or more implementations, the regularization loss is based on the parameters of the layer-specific routers for the layers of the large language model. Indeed, in some embodiments, the layer modulation system 106 utilizes the regularization loss to add a penalty term to a total loss so that the layer-specific router parameters are not too large and to prevent overfitting to noise.

Further, in some implementations, the probability penalization loss is based on the probability values determined by the layer-specific routers of the layers of the large language model. Indeed, in one or more embodiments, the layer modulation system 106 uses the probability penalization loss to favor skipping at the cost of cross-entropy loss. Moreover, in one or more implementations, the layer modulation system 106 modifies the probability penalization loss using a hyperparameter (e.g., α as described further below). In these or other embodiments, the hyperparameter indicates an extent of layer skipping specific to the query. Furthermore, in some embodiments, the layer modulation system 106 determines the hyperparameter based on the length of an input sequence of the query, an amount of computing resources available, and/or additional parameters. For instance, in one or more embodiments, the layer modulation system 106 tunes the hyperparameter to be specific to a large language model and/or dataset.

Additionally, or alternatively, in some implementations, the layer modulation system 106 determines the hyperparameter based on an amount of computing resources available. In these or other embodiments, the layer modulation system 106 determines the amount of computing resources available for executing the large language model utilizing the one or more processors. Specifically, the layer modulation system 106 determines the amount of hardware or software capabilities available to a client device associated with the query to the large language model. For instance, the layer modulation system 106 determines the constraints in processing power, memory capacity, storage availability, network bandwidth, or energy efficiency of the client device.

Additionally, in one or more embodiments, the layer modulation system 106 freezes the parameters of the large language model while training the layer-specific router 406. In particular, the layer modulation system 106 freezes parameters other than those of the layer-specific router 406 while modifying the parameters of the layer-specific router and generating the probability value 412. In one or more implementations, the layer modulation system 106 trains the layer-specific router 406 until the total loss remains stable for a specified number (e.g., 5) of batch gradient descent steps. Further, in some embodiments, the layer modulation system 106 uses a query including only the task and instruction, without attaching the responses.

Moreover, in some implementations, the layer modulation system 106 utilizes various parameters (e.g., hyperparameters in addition to the hyperparameter previously discussed) for training the layer-specific router 406. For example, in one or more embodiments, the layer modulation system 106 uses a learning rate between 1e⁻⁴ and 3e⁻⁴ and gradient accumulation steps set to 4/5. In these or other embodiments, the layer modulation system 106 uses a cosine scheduler to adjust the learning rate during training. Furthermore, in one or more implementations, the layer modulation system 106 fixes the regularization loss coefficient at a specific value (e.g., 0.01). Additionally, in some embodiments, the layer modulation system 106 tunes the hyperparameter a according to the dataset and sequence length of the query. In alternative embodiments, the layer modulation system 106 uses other values for the learning rate, gradient accumulation steps, and/or the regularization loss coefficient.

As further illustrated in FIG. 4, in some implementations, the layer modulation system 106 performs an act 414 of caching the probability value 412. Specifically, in one or more embodiments, the layer modulation system 106 caches the probability value 412 as an attribute of the layer-specific router 406 corresponding to the large language model layer 404. For example, the layer modulation system 106 caches the probability value 412 for access in inference phases subsequent to the prefill phase.

As also depicted in FIG. 4, in one or more implementations, the layer modulation system 106 uses the output of the large language model layer 404 as input to additional large language model layers 416. In these or other embodiments, the layer modulation system 106 performs the same operations described above for training the layer-specific routers of each layer to generate and cache a probability value for each layer. Indeed, in these or other embodiments, the layer modulation system 106 generates a probability value for each layer of the large language model and caches the probability value as an attribute of the layer-specific router for each layer of the large language model for access in later inference phases. Further, in these or other embodiments, the layer modulation system 106 uses the probability value of a given layer to determine to skip or to not skip the layer in the inference phases subsequent to the prefill phase 400 as described further with respect to FIG. 5.

As further illustrated in FIG. 4, in some embodiments, the layer modulation system 106 uses the large language model to generate the response token 418 (i.e., the first token of the response or token 1) in the prefill phase 400. Specifically, in some implementations, the layer modulation system 106 generates the response token 418 without skipping any layers of the large language model. Indeed, in these or other embodiments, the layer modulation system 106 uses the prefill phase to prefill the appropriate attributes of the layer-specific routers of the layers of the large language model with the probability values as well as to generate the first token of the response.

As noted above, in one or more embodiments, the layer modulation system 106 generates tokens of the response by skipping a set of one or more layers of the large language model based on the probability values of the layers. Indeed, in one or more implementations, the layer modulation system 106 skips layers of the large language model when generating tokens of the response by determining an individual probability value for each layer. FIG. 5 illustrates a diagram of the layer modulation system 106 generating tokens of a response to a query by skipping a set of one or more layers of a large language model in subsequent inference phases in accordance with one or more embodiments.

As depicted in FIG. 5, in some embodiments, the layer modulation system 106 uses a large language model to generate tokens of the response (i.e., response tokens 520) to a query. In particular, the layer modulation system 106 generates the response tokens 520 in inference phases subsequent to the prefill phase (i.e., subsequent phases 500) based on an input 502. For instance, in some implementations, the layer modulation system 106 uses the output of a preceding layer as the input 502 in the subsequent phases 500.

In one or more embodiments, a subsequent phase includes an inference phase of the large language model. Specifically, in one or more implementations, a subsequent phase includes an inference phase subsequent to the prefill (or first) phase of inference. For example, in some embodiments, a subsequent phase includes a second, third, fourth, etc. phase of inference of the large language model by which the layer modulation system 106 generates a second token, a third token, a fourth token, etc., respectively, of the response to a query to the large language model.

As additionally shown in FIG. 5, in some implementations, the layer modulation system 106 uses a layer-specific router 506 corresponding to the large language model layer 504 as part of generating the response tokens 520. In particular, the layer modulation system 106 uses the layer-specific router 506 to determine whether to skip the large language model layer 504. For instance, the layer modulation system 106 determines whether to skip the large language model layer 504 based on a probability value 510 specific to the large language model layer 504. In one or more embodiments, the probability value 510 indicates a probability of not skipping the large language model layer 504, though in alternative embodiments, the probability value 510 indicates a probability of skipping the large language model layer 504.

As further illustrated in FIG. 5, in one or more embodiments, the layer modulation system 106 uses the probability value 510 to determine whether to skip the large language model layer 504. Specifically, the layer modulation system 106 accesses the probability value 510 from the layer-specific router 506. Moreover, in one or more implementations, the layer modulation system 106 determines whether the probability value 510 exceeds a threshold t. Based on determining that the probability value 510 exceeds (or equals) the threshold t, the layer modulation system 106 does not skip the large language model layer 504. Conversely, based on determining that the probability value 510 does not exceed (or equal) the threshold t, the layer modulation system 106 skips the large language model layer 504.

To illustrate, if the layer modulation system 106 determines that the probability value 510 exceeds (or equals) the threshold τ (e.g., 0.5), the layer modulation system 106 uses an attention head 512 and feedforward network 514 corresponding to the large language model layer 504 to generate an output 516. In these or other embodiments, the layer modulation system 106 uses the attention head 512 and the feedforward network 514 with finetuned parameters as described with respect to FIG. 6. In contrast, if the layer modulation system 106 determines that the probability value 510 does not exceed (or equal) the threshold τ (e.g., 0.5), the layer modulation system 106 skips the large language model layer 504 and utilizes the input 502 as the output 516. In some embodiments, the layer modulation system 106 utilizes a value between 0 and 1 (e.g., 0.5) as the threshold τ.

As also depicted in FIG. 5, in some implementations, the layer modulation system 106 determines whether to skip additional layers of the large language model (i.e., additional large language model layers 518). In particular, the layer modulation system 106 uses the output 516 as input to an additional layer of the large language model and repeats the process described above to determine whether to skip the additional layer of the large language model. Indeed, in one or more embodiments, the layer modulation system 106 performs the same process for each layer of the large language model in the subsequent phases 500.

To illustrate, the layer modulation system 106 generates the response tokens 520 in the subsequent phases 500 by skipping layers of the large language model. Specifically, the layer modulation system 106 uses the probability values of the layers generated during the prefill phase (e.g., the prefill phase 400) to determine which layers to skip as described above. In one or more implementations, the layer modulation system 106 uses the same set of layers (and skips the same set of layers) of the large language model for each inference phase for generating a response to a given query because the probability values determined in the prefill phase remain the same throughout the subsequent phases 500 of response generation.

As further illustrated in FIG. 5, in some embodiments, the layer modulation system 106 uses the layers of the large language model to generate the response tokens 520. In particular, the layer modulation system 106 generates a second token (i.e., token 2) of the response in a first subsequent phase of the large language model. Indeed, the layer modulation system 106 performs as many subsequent phases 500 as necessary to generate the response tokens 520 through a final response token (i.e., token n).

As additionally illustrated in FIG. 5, in one or more embodiments, the layer modulation system 106 utilizes a key-value cache 522 to generate the response tokens 520. Specifically, in some embodiments, the layer modulation system 106 utilizes key and value information of previous tokens in the key-value cache 522 to generate the output 516 for the layer 504. For example, when the layer modulation system 106 determines not to skip the layer 504, the layer modulation system 106 utilizes the key and value information of the previous generated tokens of the key-value cache 522. Indeed, in one or more implementations, the layer modulation system 106 utilizes the information of the key-value cache 522 when generating outputs for each layer of the large language model that is not skipped in the subsequent phases.

As mentioned previously, in some implementations, the layer modulation system 106 finetunes the parameters of the layers of the large language model using low rank adapters. Indeed, in one or more embodiments, the layer modulation system 106 finetunes the parameters of the layers of the large language model in an additional training phase. FIG. 6 illustrates a diagram of the layer modulation system 106 finetuning the parameters of the large language model using low rank adapters in accordance with one or more embodiments.

As illustrated in FIG. 6, in one or more implementations, the layer modulation system 106 finetunes the parameters of a large language model layer 602 in a low rank adapter training phase 600. Specifically, in some embodiments, the low rank adapter training phase 600 is a second training phase of a series of training phases. For example, in some implementations, the layer modulation system 106 trains layer-specific routers of the large language model in a first training phase and trains the parameters of the large language model layers in a second training phase.

As additionally shown in FIG. 6, in one or more embodiments, the layer modulation system 106 finetunes the parameters of the large language model layer 602 by receiving an input 604 and generating an embedding 616 (e.g., a hidden state). In particular, the layer modulation system 106 finetunes the parameters of the large language model layer 602 using low rank adapters associated with the large language model layer 602. For instance, in one or more implementations, the layer modulation system 106 assigns a low rank adapter (i.e., low rank adapter 1 608) to an attention head 610 of the large language model layer 602. Furthermore, in some embodiments, the layer modulation system 106 assigns a second low rank adapter (i.e., low rank adapter 2 612) to a feedforward network 614 of the large language model layer 602.

As further illustrated in FIG. 6, in some implementations, the layer modulation system 106 finetunes the parameters of the large language model layer 602 using the low rank adapters. Specifically, the layer modulation system 106 uses the low rank adapter 1 608 assigned to the attention head 610 and the low rank adapter 2 612 assigned to the feedforward network 614 to modify the weights of pre-trained parameters 606 of the large language model layer 602. Additionally, in one or more embodiments, the layer modulation system 106 freezes the parameters of the layer-specific router associated with the large language model layer 602 while finetuning the parameters of the large language model layer 602. Further, in one or more implementations, the layer modulation system 106 uses a rank of 8 and a dropout rate of 0.1 for the low rank adapters (low rank adapter 1 608 and low rank adapter 2 612).

Moreover, in some embodiments, the layer modulation system 106 uses a loss for finetuning the parameters of the large language model layer 602. In particular, the layer modulation system 106 uses a cross entropy loss and/or a probability penalization loss similar to the probability penalization loss described above. For example, the layer modulation system 106 uses a probability penalization loss with the hyperparameter scaled down (e.g., by a factor of 3 to 4). To illustrate, in some implementations, the layer modulation system 106 uses cross entropy loss with the scaled down probability penalization loss as follows:

$$Cross - Entropy Loss + λ Regularization Loss + \frac{α}{3} {\sum }_{layers} prob$$

Furthermore, in one or more embodiments, the layer modulation system 106 utilizes responses in the low rank adapter training phase. Specifically, the layer modulation system 106 appends the responses to the query to train the large language model to predict tokens for the response. At inference (e.g., during the inference phases), the layer modulation system 106 merges the modified weights with the original weights. In one or more implementations, this merging of weights prevents latency overhead.

As also depicted in FIG. 6, in some embodiments, the layer modulation system 106 finetunes the parameters of additional large language model layers 618. In particular, the layer modulation system 106 finetunes the parameters of the additional large language model layers 618 as described above with respect to the large language model layer 602. Indeed, in some implementations, the layer modulation system 106 finetunes the parameters of all the layers of the large language model as described previously.

As noted previously, in one or more embodiments, the layer modulation system 106 generates tokens of a response to a query to the large language model by skipping layers of the large language model. Indeed, in one or more implementations, the layer modulation system 106 skips a query-specific set of layers of the large language model to generate the tokens. FIG. 7 illustrates a diagram of the layer modulation system 106 skipping a query-specific set of layers of a large language model to generate response tokens in accordance with one or more embodiments.

As shown in FIG. 7, in some embodiments, the layer modulation system 106 uses the large language model 706 to generate tokens of a response to a query. Specifically, in response to receiving a first query (e.g., query A 702 with input sequence A), the layer modulation system 106 uses the large language model 706 to generate the response tokens A 712. Similarly, in response to receiving a second query (e.g., query B 704 with input sequence B), the layer modulation system 106 uses the large language model 706 to generate the response tokens B 714.

In some implementations, the layer modulation system 106 generates a first token (i.e., token 1) of a response to query A as described above with respect to FIG. 4. In particular, the layer modulation system 106 generates the token using all the layers of the large language model in a prefill phase. In these or other embodiments, the layer modulation system 106 also uses a layer-specific router to generate the probability value for each layer (e.g., layers 1-n) of the large language model 706 for storage as an attribute of the layer-specific router. Additionally, in one or more embodiments, the layer modulation system 106 generates a first token (i.e., token 1) of a response to query B in the same manner.

As further illustrated in FIG. 7, in one or more implementations, the layer modulation system 106 generates a set of additional response tokens in the subsequent phases. Specifically, the layer modulation system 106 generates the additional response tokens by skipping a query-specific set of layers of the large language model 706 in response to receiving each query. For instance, the layer modulation system 106 uses the probability values (PV) from layer-specific router to determine whether to skip the associated layer of the large language model 706.

To illustrate, the layer modulation system 106 generates the additional response tokens A 712 (e.g., token 2-token n) by skipping the query-specific set of layers of the large language model 706 as illustrated by pathway 708. In particular, to determine which layers belong to the query-specific set of layers that the layer modulation system 106 skips, the layer modulation system 106 uses the probability values (PV₁) determined in the prefill phase for query A 702.

In this example, the layer modulation system 106 determines that the probability value (PV₁) of layer 2 does not exceed t while the probability values (PV₁) of layers 1, 3, and n do exceed τ. In this example, therefore, the layer modulation system 106 determines layer 2 is included in the query-specific set of layers to skip when generating the response tokens A 712. Indeed, the layer modulation system 106 skips layer 2, but uses layers 1, 3, and n as illustrated by pathway 708 to generate response token 2, response token 3, and so forth to the final token n of the response.

Additionally, as illustrated, the layer modulation system 106 uses the probability values (PV₂) determined in the prefill phase for query B 704 to determine a separate query-specific set of layers to skip. To further illustrate, the layer modulation system 106 generates the additional response tokens B 714 in response to receiving query B 704 in a similar manner as just described. Specifically, the layer modulation system 106 skips layer 3 as illustrated by pathway 710. For example, the layer modulation system 106 determines that the probability value (PV₂) of layer 3 does not exceed t while the probability values (PV₂) of layers 1, 2, and n do.

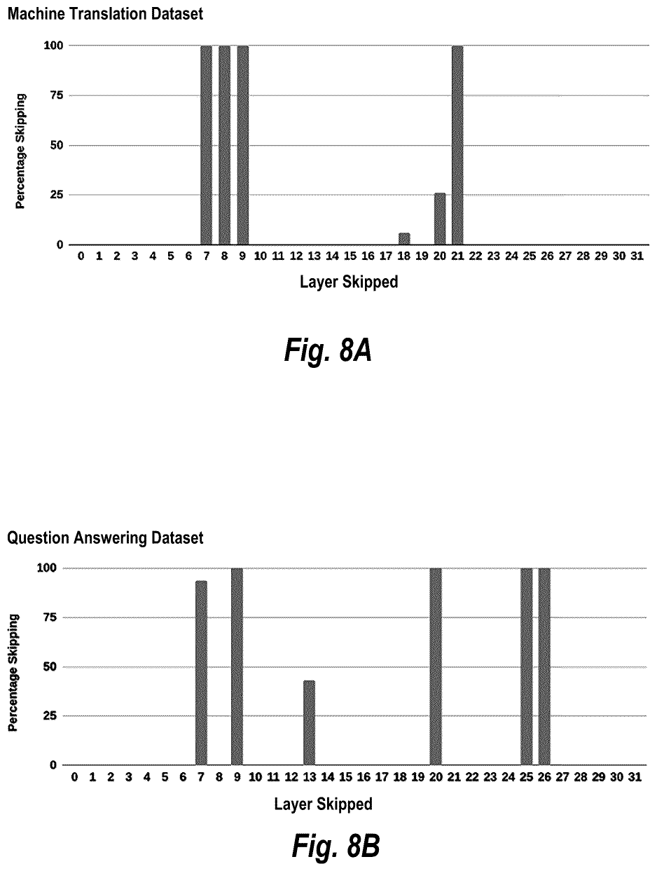

As previously mentioned, in some embodiments, the layer modulation system 106 improves the accuracy, efficiency, and flexibility of generating responses using large language models on resource constrained devices. Indeed, in some implementations, the layer modulation system 106 improves accuracy, efficiency, and flexibility by skipping a query-specific set of large language model layers. FIGS. 8A and 8B illustrate layer skipping statistics of the layer modulation system 106 across different tasks in accordance with one or more embodiments.

FIG. 8A illustrates layer skipping statistics of the layer modulation system 106 for a machine translation dataset and FIG. 8B illustrates layer skipping statistics of the layer modulation system 106 for a question answering dataset. While the layer modulation system 106 skips some layers of the large language model for a similar percentage of the queries in each dataset (e.g., layers 7 and 9), the layer modulation system 106 skips significantly different sets of layers of the large language model for the two different datasets. For example, the layer modulation system 106 skips layer 8 for approximately 100% of the queries in the machine translation dataset as opposed to approximately 0% of the queries in the question answering dataset. Further differences in the query specific set of layers that the layer modulation system 106 skips are apparent in the two datasets as illustrated in FIGS. 8A and 8B.

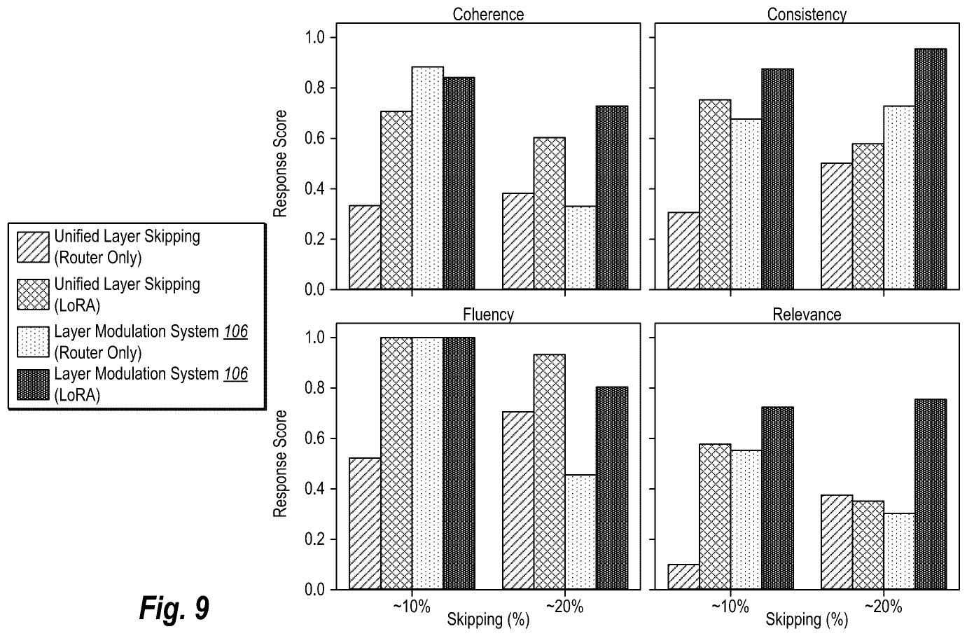

As previously noted, in one or more implementations, the layer modulation system 106 improves the accuracy, efficiency, and flexibility of generating responses using large language models on resource constrained devices. Indeed, in some embodiments, the layer modulation system 106 improves the accuracy, efficiency, and flexibility by skipping a query-specific set of large language model layers and finetuning the layers using low rank adapters when generating responses as described above. FIG. 9 illustrates large language model response metrics achieved by the layer modulation system 106 compared with example prior art large language model response metrics in accordance with one or more embodiments.

As portrayed in FIG. 9, in some implementations, the layer modulation system 106 improves large language model response metrics (or simply response metrics) of large language model generated responses such as coherence, consistency, fluency, and relevance. For instance, the layer modulation system 106 improves response scores which evaluate generated summaries against target summaries. For example, the layer modulation system 106 improves these response metrics relative to methods that implement unified layer skipping (i.e., skipping the same layers without regard to the query and/or input sequence). Indeed, in one or more embodiments, the layer modulation system 106 often improves the response metrics in a router only implementation (e.g., using the layer-specific routers only) or low rank adapter (“LoRA”) implementation (e.g., using both the layer-specific routers and low rank adapters). Further, the layer modulation system 106 generally improves these response metrics when skipping 10% to 20% of the layers of the large language model which represents the optimal skipping range where the quality loss is minimal and the latency improvement is significant.

Turning to FIG. 10, additional detail will now be provided regarding various components and capabilities of the layer modulation system 106. In particular, FIG. 10 illustrates an example schematic diagram of a computing device 1000 (e.g., the server device(s) 102 and/or the client device 110) implementing the layer modulation system 106 in accordance with one or more embodiments of the present disclosure for components 1000-1008. As illustrated in FIG. 10, the layer modulation system 106 includes a large language model(s) 114, a prefill phase manager 1002, a subsequent phase manager 1004, a finetuning manager 1006, and storage manager 1008.

In one or more implementations, the prefill phase manager 1002 generates a first response token and probability values for the layers of the large language model. For instance, the prefill phase manager 1002 receives a query to the large language model(s) 114 from a client device and uses the large language model(s) 114 to generate first token in a prefill phase of inference for an input sequence of the query. Moreover, in some embodiments, the prefill phase manager 1002 determines a probability value indicating to skip or not skip a layer of the large language model using a layer-specific router. Furthermore, in some implementations, the prefill phase manager 1002 caches the probability values for the layers of the large language model(s) 114 as attributes of the layer-specific routers.

Additionally, the subsequent phase manager 1004 generates additional response tokens of a response to the query to the large language model(s) 114. In particular, the subsequent phase manager 1004 generates the additional response tokens (e.g., a second token, a third token, etc.) by skipping a query-specific set of layers of the large language model(s) 114. For example, the subsequent phase manager 1004 accesses the layer-specific router for each layer to determine which layers belong to the query-specific set of layers for skipping based on the probability values.

Further, the finetuning manager 1006 finetunes parameters of the layers of the large language model(s) 114. Specifically, the finetuning manager 1006 uses low rank adapters associated with the layers of the large language model(s) 114 to finetune the parameters. Moreover, in one or more embodiments, the finetuning manager 1006 finetunes the parameters of the large language model(s) 114 while freezing parameters of the layer-specific routers.

Furthermore, as shown in FIG. 10, the layer modulation system 106 includes a storage manager 1008. In one or more implementations, the storage manager 1008 stores information (e.g., via one or more memory devices) on behalf of the layer modulation system 106. For example, the storage manager 1008 includes a database for storing query tokens, response tokens, probability values, and/or low rank adapters.

In one or more implementations, each of the components 1002-1008 of the layer modulation system 106 include software, hardware, or both. For example, the components 1002-1008 include one or more instructions stored on a computer-readable storage medium and executable by processors of one or more computing devices, such as a client device or server device. When executed by the one or more processors, the computer-executable instructions of the layer modulation system 106 cause the computing device(s) to perform the methods described herein. Alternatively, the components 1002-1008 include hardware, such as a special-purpose processing device to perform a certain function or group of functions. Alternatively, the components 1002-1008 of the layer modulation system 106 include a combination of computer-executable instructions and hardware.

Furthermore, the components 1002-1008 of the layer modulation system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 1002-1008 of the layer modulation system 106 are implemented as a stand-alone application, such as a desktop or mobile application. Furthermore, in various embodiments, the components 1002-1008 of the layer modulation system 106 are implemented as one or more web-based applications hosted on a remote server. Alternatively, or additionally, the components 1002-1008 of the layer modulation system 106 are implemented in a suite of mobile device applications or “apps.” For example, in one or more embodiments, the layer modulation system 106 comprises or operates in connection with digital software applications such as ADOBE® ACROBAT®, ADOBE® DOCUMENT CLOUD®, and/or ADOBE® EXPERIENCE PLATFORM. The foregoing are either registered trademarks or trademarks of Adobe Inc. in the United States and/or other countries.

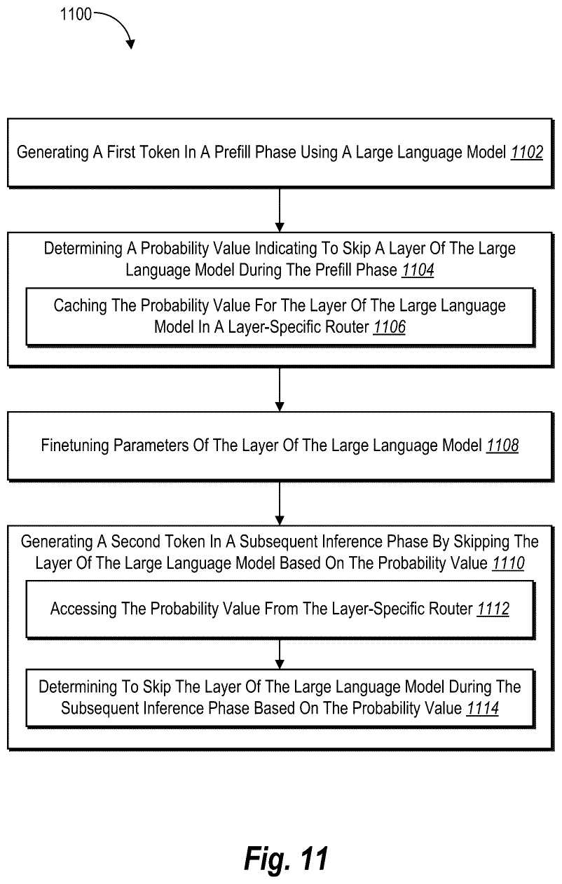

FIGS. 1-10, the corresponding text, and the examples provide a number of different systems, methods, and non-transitory computer readable media for generating an artificial intelligence response to a query using a large language model by skipping a query-specific set of layers of the large language model. In addition to the foregoing, embodiments can also be described in terms of flowcharts comprising acts for accomplishing a particular result. For example, FIG. 11 illustrates a flowchart of an example sequence of acts in accordance with one or more embodiments.

While FIG. 11 illustrates acts according to some embodiments, alternative embodiments may omit, add to, reorder, and/or modify any of the acts shown in FIG. 11. The acts of FIG. 11 can be performed as part of a method. Alternatively, a non-transitory computer readable medium can comprise instructions, that when executed by one or more processors, cause a computing device to perform the acts of FIG. 11. In still further embodiments, a system can perform the acts of FIG. 11. Additionally, the acts described herein may be repeated or performed in parallel with one another or in parallel with different instances of the same or other similar acts.

FIG. 11 illustrates an example series of acts 1100 for generating an artificial intelligence response to a query using a large language model by skipping a query-specific set of layers of the large language model. The series of acts 1100 can include an act 1102 of generating a first token in a prefill phase using a large language model; an act 1104 of determining a probability value indicating to skip a layer of the large language model during the prefill phase; an act 1106 of caching the probability value for the layer of the large language model in a layer-specific router; an act 1108 of finetuning parameters of the layer of the large language model; an act 1110 of generating a second token in a subsequent inference phase by skipping the layer of the large language model based on the probability value; an act 1112 of accessing the probability value from the layer-specific router; and an act 1114 of determining to skip the layer of the large language model during the subsequent inference phase based on the probability value.

In some embodiments, the act 1102 includes generating, using a large language model and in response to a query to the large language model, a first token in a prefill phase for an input sequence from the query. In some embodiments, the act 1104 also includes an act of determining, during the prefill phase and utilizing a layer-specific router corresponding to a layer of the large language model, a probability value indicating to skip the layer of the large language model. In some implementations, the act 1110 further includes an act of generating, using the large language model, a second token in a subsequent phase by skipping the layer of the large language model based on the probability value.

In some implementations, the series of acts 1100 includes caching, as an attribute of the layer-specific router, the probability value for the layer of the large language model.

In one or more embodiments, generating, using the large language model, the second token in the subsequent phase by skipping the layer of the large language model based on the probability value includes accessing the probability value from the layer-specific router. Additionally, in one or more embodiments, the series of acts 1100 includes an act of determining to skip the layer of the large language model during the subsequent phase based on the probability value.

In one or more implementations, the series of acts 1100 includes determining, during the prefill phase and utilizing an additional layer-specific router corresponding to an additional layer of the large language model, an additional probability value indicating to not skip the additional layer of the large language model. In one or more implementations, the series of acts 1100 also includes an act of generating, using the large language model, the second token in the subsequent phase by not skipping the additional layer of the large language model based on the additional probability value.

In some embodiments, the series of acts 1100 includes modifying, during the prefill phase, parameters of the layer-specific router using a probability penalization loss determined based on a plurality of probability values determined by a plurality of layer-specific routers corresponding to a plurality of layers of the large language model.

In some implementations, modifying the parameters of the layer-specific router using the probability penalization loss includes determining a hyperparameter that modifies the probability penalization loss by indicating an extent of layer skipping specific to the query based on a length of the input sequence of the query.

In one or more embodiments, modifying the parameters of the layer-specific router using the probability penalization loss includes determining a total loss based on a combination of a cross-entropy loss based on predicted probability distributions of the large language model. In some embodiments, the series of acts 1100 further includes an act of a regularization loss based on parameters of the plurality of layer-specific routers. Additionally, in some implementations, the series of acts 1100 includes an act of the probability penalization loss. In one or more embodiments, the series of acts 1100 also includes an act of modifying the parameters of the layer-specific router using the total loss.

In one or more embodiments, the series of acts 1100 includes generating, using the large language model, the first token in the prefill phase by generating the first token without skipping any layers of the large language model.

In some embodiments, the series of acts 1100 includes finetuning, using one or more low rank adapters associated with the layer of the large language model, parameters of the layer of the large language model while freezing parameters of the layer-specific router.

In some implementations, the act 1102 includes determining, during a prefill phase of processing an input sequence via a large language model, probability values for layers of the large language model utilizing a plurality of layer-specific routers corresponding to the layers of the large language model. In one or more implementations, the act 1108 further includes an act of finetuning, using low rank adapters associated with the layers of the large language model, parameters of the layers of the large language model while freezing parameters of the plurality of layer-specific routers. Additionally, in some embodiments, the act 1110 includes an act of generating, using the large language model with the finetuned parameters, one or more tokens in one or more inference phases by skipping one or more layers of the large language model based on the probability values.

In one or more embodiments, the series of acts 1100 includes finetuning the parameters of the layers of the large language model by assigning a first low rank adapter to an attention head of a layer of the layers of the large language model. In some implementations, the series of acts 1100 also includes an act of assigning a second low rank adapter to a feedforward network of the layer. In one or more embodiments, the series of acts 1100 further includes an act of finetuning the parameters of the layer using the first low rank adapter and the second low rank adapter.

In one or more implementations, the series of acts 1100 includes modifying, in connection with the input sequence, the parameters of the plurality of layer-specific routers in a first training phase and finetuning the parameters of the layers of the large language model in a second training phase.

In some embodiments, the series of acts 1100 includes modifying the parameters of the plurality of layer-specific routers using a cross-entropy loss based on predicted probability distributions of the large language model, a regularization loss based on the parameters of the plurality of layer-specific routers, and a probability penalization loss based on a plurality of probability values determined by the plurality of layer-specific routers corresponding to a plurality of layers of the large language model.

In some implementations, modifying the parameters of the plurality of layer-specific routers using the probability penalization loss includes determining an amount of computing resources available for executing the large language model utilizing the one or more processors. Additionally, in one or more implementations, the series of acts 1100 includes an act of determining a hyperparameter of the probability penalization loss based on the amount of computing resources available.

In one or more embodiments, the series of acts 1100 includes determining additional probability values for the layers of the large language model during a prefill phase of processing an additional input sequence via the large language model. In some embodiments, the series of acts 1100 also includes an act of generating, using the large language model, a set of tokens corresponding to the additional input sequence by skipping a query-specific set of layers of the large language model based on the additional probability values.

In one or more implementations, the act 1102 includes generating, using a large language model and in response to a query to the large language model, a first token in a first inference phase for an input sequence from the query. In some implementations, the act 1104 further includes an act of determining, during the first inference phase and utilizing a plurality of layer-specific routers corresponding to layers of the large language model, a plurality of probability values indicating to skip one or more layers of the layers of the large language model. Additionally, in one or more embodiments, the act 1106 includes an act of caching, as attributes of the plurality of layer-specific routers, the plurality of probability values for the layers of the large language model. In one or more implementations, the act 1110 also includes an act of generating, using the large language model and information of a key-value cache, a second token in a second inference phase by skipping the one or more layers of the large language model based on the plurality of probability values accessed from the plurality of layer-specific routers.

In some embodiments, generating the second token in the second inference phase by skipping the one or more layers of the large language model based on the plurality of probability values includes determining to skip a layer of the one or more layers of the large language model based on a probability value corresponding to the layer. In some embodiments, the series of acts 1100 further includes an act of determining to not skip an additional layer of the one or more layers of the large language model based on an additional probability value corresponding to the additional layer.

In some implementations, the series of acts 1100 includes accessing the probability value and the additional probability value via the plurality of layer-specific routers. Additionally, in some implementations, the series of acts 1100 includes an act of determining that the probability value does not exceed a threshold. In one or more embodiments, the series of acts 1100 also includes an act of determining that the additional probability value exceeds the threshold.

In one or more embodiments, the series of acts 1100 includes modifying, during a first training stage of the first inference phase, parameters of the plurality of layer-specific routers. In one or more implementations, the series of acts 1100 further includes an act of finetuning, during a second training stage of the first inference phase and using low rank adapters associated with the layers of the large language model, parameters of the layers of the large language model. In one or more implementations, modifying the parameters of the plurality of layer-specific routers includes modifying the parameters of the plurality of layer-specific routers using a probability penalization loss based on the plurality of probability values and a hyperparameter that modifies the probability penalization loss by indicating an extent of layer skipping specific to the query based on a length of the input sequence of the query.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 12 illustrates, in block diagram form, an example computing device 1200 (e.g., the computing device 1000, the client device 110, and/or the server device(s) 102) that may be configured to perform one or more of the processes described above. As shown by FIG. 12, the computing device can comprise a processor(s) 1202, memory 1204, a storage device 1206, an I/O interface 1208, and a communication interface 1210.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them. The computing device 1200 includes memory 1204, which is coupled to the processor(s) 1202. The memory 1204 may be used for storing data, metadata, and programs for execution by the processor(s). The memory 1204 may include one or more of volatile and non-volatile memories. The memory 1204 may be internal or distributed memory. The computing device 1200 includes a storage device 1206 includes storage for storing data or instructions. As an example, and not by way of limitation, storage device 1206 can comprise a non-transitory storage medium described above. The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices (e.g., computing device 1200) or one or more networks. The computing device 1200 can further include a bus 1212. The bus 1212 can comprise hardware, software, or both that couples components of computing device 1200 to each other.

What is claimed is:

1. A computer-implemented method comprising:
generating, using a large language model and in response to a query to the large language model, a first token in a prefill phase for an input sequence from the query;
determining, during the prefill phase and utilizing a layer-specific router corresponding to a layer of the large language model, a probability value indicating to skip the layer of the large language model; and
generating, using the large language model, a second token in a subsequent phase by skipping the layer of the large language model based on the probability value.

2. The computer-implemented method of claim 1, further comprising caching, as an attribute of the layer-specific router, the probability value for the layer of the large language model.

3. The computer-implemented method of claim 2, wherein generating, using the large language model, the second token in the subsequent phase by skipping the layer of the large language model based on the probability value comprises:
accessing the probability value from the layer-specific router; and
determining to skip the layer of the large language model during the subsequent phase based on the probability value.

4. The computer-implemented method of claim 1, further comprising:
determining, during the prefill phase and utilizing an additional layer-specific router corresponding to an additional layer of the large language model, an additional probability value indicating to not skip the additional layer of the large language model; and
generating, using the large language model, the second token in the subsequent phase by not skipping the additional layer of the large language model based on the additional probability value.

5. The computer-implemented method of claim 1, further comprising modifying, during the prefill phase, parameters of the layer-specific router using a probability penalization loss determined based on a plurality of probability values determined by a plurality of layer-specific routers corresponding to a plurality of layers of the large language model.

6. The computer-implemented method of claim 5, wherein modifying the parameters of the layer-specific router using the probability penalization loss comprises determining a hyperparameter that modifies the probability penalization loss by indicating an extent of layer skipping specific to the query based on a length of the input sequence of the query.

7. The computer-implemented method of claim 5, wherein modifying the parameters of the layer-specific router using the probability penalization loss comprises:
determining a total loss based on a combination of:
a cross-entropy loss based on predicted probability distributions of the large language model;
a regularization loss based on parameters of the plurality of layer-specific routers; and
the probability penalization loss; and
modifying the parameters of the layer-specific router using the total loss.

8. The computer-implemented method of claim 1, wherein generating, using the large language model, the first token in the prefill phase comprises generating the first token without skipping any layers of the large language model.

9. The computer-implemented method of claim 1, further comprising finetuning, using one or more low rank adapters associated with the layer of the large language model, parameters of the layer of the large language model while freezing parameters of the layer-specific router.

10. A system comprising:
one or more memory devices; and
one or more processors configured to cause the system to:
determine, during a prefill phase of processing an input sequence via a large language model, probability values for layers of the large language model utilizing a plurality of layer-specific routers corresponding to the layers of the large language model;
finetune, using low rank adapters associated with the layers of the large language model, parameters of the layers of the large language model while freezing parameters of the plurality of layer-specific routers; and
generate, using the large language model with the finetuned parameters, one or more tokens in one or more inference phases by skipping one or more layers of the large language model based on the probability values.

11. The system of claim 10, wherein the one or more processors are further configured to finetune the parameters of the layers of the large language model by:
assigning a first low rank adapter to an attention head of a layer of the layers of the large language model;
assigning a second low rank adapter to a feedforward network of the layer; and
finetuning the parameters of the layer using the first low rank adapter and the second low rank adapter.

12. The system of claim 10, wherein the one or more processors are further configured to modify, in connection with the input sequence, the parameters of the plurality of layer-specific routers in a first training phase and finetune the parameters of the layers of the large language model in a second training phase.

13. The system of claim 10, wherein the one or more processors are further configured to modify the parameters of the plurality of layer-specific routers using a cross-entropy loss based on predicted probability distributions of the large language model, a regularization loss based on the parameters of the plurality of layer-specific routers, and a probability penalization loss based on a plurality of probability values determined by the plurality of layer-specific routers corresponding to a plurality of layers of the large language model.

14. The system of claim 13, wherein modifying the parameters of the plurality of layer-specific routers using the probability penalization loss comprises:
determining an amount of computing resources available for executing the large language model utilizing the one or more processors; and
determining a hyperparameter of the probability penalization loss based on the amount of computing resources available.

15. The system of claim 10, wherein the one or more processors are further configured to:
determine additional probability values for the layers of the large language model during a prefill phase of processing an additional input sequence via the large language model; and
generate, using the large language model, a set of tokens corresponding to the additional input sequence by skipping a query-specific set of layers of the large language model based on the additional probability values.

16. A non-transitory computer readable medium storing executable instructions which, when executed by a processing device, cause the processing device to perform operations comprising:
generating, using a large language model and in response to a query to the large language model, a first token in a first inference phase for an input sequence from the query;
determining, during the first inference phase and utilizing a plurality of layer-specific routers corresponding to layers of the large language model, a plurality of probability values indicating to skip one or more layers of the layers of the large language model;
caching, as attributes of the plurality of layer-specific routers, the plurality of probability values for the layers of the large language model; and
generating, using the large language model and information of a key-value cache, a second token in a second inference phase by skipping the one or more layers of the large language model based on the plurality of probability values accessed from the plurality of layer-specific routers.

17. The non-transitory computer readable medium of claim 16, wherein generating the second token in the second inference phase by skipping the one or more layers of the large language model based on the plurality of probability values comprises:
determining to skip a layer of the one or more layers of the large language model based on a probability value corresponding to the layer; and
determining to not skip an additional layer of the one or more layers of the large language model based on an additional probability value corresponding to the additional layer.

18. The non-transitory computer readable medium of claim 17, wherein the operations further comprise:
accessing the probability value and the additional probability value via the plurality of layer-specific routers;
determining that the probability value does not exceed a threshold; and
determining that the additional probability value exceeds the threshold.

19. The non-transitory computer readable medium of claim 16, wherein the operations further comprise:
modifying, during a first training stage of the first inference phase, parameters of the plurality of layer-specific routers; and
finetuning, during a second training stage of the first inference phase and using low rank adapters associated with the layers of the large language model, parameters of the layers of the large language model.

20. The non-transitory computer readable medium of claim 19, wherein modifying the parameters of the plurality of layer-specific routers comprises modifying the parameters of the plurality of layer-specific routers using a probability penalization loss based on the plurality of probability values and a hyperparameter that modifies the probability penalization loss by indicating an extent of layer skipping specific to the query based on a length of the input sequence of the query.
